(19) United States
(12) Patent Application Publication
(10) Pub. No.: US 2026/0349806 A1
(43) Pub. Date: Nov. 5, 2026

(54) SYSTEM FOR ORCHESTRATING TASK-SPECIFIC AI ENGINES IN A MULTI-LAYERED AI ARCHITECTURE

(71) Applicant: BANK OF AMERICA CORPORATION, Charlotte, NC (US)

(72) Inventors: Manu Jacob Kurian, Dallas, TX (US); Ryan Scott Heller, Middletown, DE (US); Marshall A. Johnson, Summit, NJ (US); Jessica L. Dunn, Mount Holly, NC (US); Glenn Seagraves, Charlotte, NC (US); Sanjay K. Dua, Charlotte, NC (US)

(73) Assignee: BANK OF AMERICA CORPORATION, Charlotte, NC (US)

(21) Appl. No.: 19/194,507

(22) Filed: Apr. 30, 2025

(51) Int. Cl. G06F 9/50

(52) U.S. Cl. CPC G06F 9/5027

(57) ABSTRACT

Systems, computer program products, and methods are described herein for orchestrating task-specific artificial intelligence (AI) processing using a multi-layered AI architecture. An orchestration AI engine receives an input task request from an end-point device, segments the request into a plurality of task portions based on task segmentation criteria, and identifies data sources corresponding to each task portion. The orchestration AI engine assigns the task portions and associated data to a plurality of agentic AI engines, each configured to execute a specific task using the provided data. The orchestration AI engine receives outputs from the agentic AI engines, processes the outputs based on output processing criteria associated with the task request, generates a final output based on the processed results, and transmits the final output to the end-point device.

### TECHNOLOGICAL FIELD

Embodiments of the disclosure relate to artificial intelligence (AI) systems, specifically to AI architectures that implement a plurality of specialized agentic AI engines operating under the supervision of an orchestration AI engine.

### BACKGROUND

Embodiments of the disclosure relate to artificial intelligence (AI) systems, where AI engines are trained on large and diverse datasets and tasked with multiple disparate functions. Conventional AI architectures often suffer from performance inefficiencies due to the broad scope of data used for training and the wide range of tasks assigned to individual AI engines. These inefficiencies may lead to incorrect outputs, as AI engines may struggle to filter relevant data for specific tasks.

Additionally, existing AI systems often require significant manual oversight to identify and correct erroneous outputs. Such oversight is particularly challenging in real-time AI deployments, where AI engines may be configured to autonomously make decisions or opt into actions based on their outputs. The lack of structured orchestration among AI components may result in increased computational overhead, inefficient resource utilization, and reduced accuracy in AI-generated outputs.

There remains a need for a system that improves the accuracy and efficiency of AI operations by segmenting AI functionalities into specialized agentic AI engines, each dedicated to a single task and trained on a narrowly defined dataset. Further, there is a need for an orchestration AI engine capable of aggregating and managing outputs from multiple agentic AI engines to ensure the correct and efficient execution of AI-driven tasks.

Applicant has identified a number of deficiencies and problems associated with orchestrating task-specific AI engines in a multi-layered AI architecture. Many of these identified problems have been solved by developing solutions that are included in embodiments of the present disclosure, many examples of which are described in detail herein.

### BRIEF SUMMARY

Systems, methods, and computer program products are provided for orchestrating task-specific AI engines in a multi-layered AI architecture.

In one aspect, a system for orchestrating agentic AI engines is presented. The system comprising: a plurality of agentic AI engines; and an orchestration AI engine operatively coupled to the plurality of agentic AI engines, wherein each agentic AI engine is configured to: receive, from the orchestration AI engine, a task portion and corresponding data sources for executing the task portion; execute the task portion using datasets from the corresponding data sources; and generate an output corresponding to the task portion based on the execution of the task portion, and wherein the orchestration AI engine is configured to: receive, from an end-point device, an input task request; segment the input task request into a plurality of task portions based on task segmentation criteria; determine a plurality of data sources associated with the plurality of task portions; and assign the plurality of task portions and the plurality of data sources to the plurality of agentic AI engines for execution.

In some embodiments, the orchestration AI engine is further configured to: receive a plurality of outputs from the plurality of agentic AI engines; process the plurality of outputs based on output processing criteria associated with the input task request; generate a final output based on processing the plurality of outputs; and transmit the final output to the input task request to the end-point device.

In some embodiments, the orchestration AI engine is further configured to: determine operational capability of each agentic AI engine based on at least one of a task complexity, processing capability, historical accuracy, or resource availability; and assign the plurality of task portions to the plurality of agentic AI engines based on the operational capability of each agentic AI engine.

In some embodiments, the orchestration AI engine is further configured to: dynamically allocate computational resources to each agentic AI engine based on at least one of a complexity of the assigned task portion, data processing requirements of the assigned task portion, or an expected computational load associated with executing the assigned task portion.

In some embodiments, for each agentic AI engine, the orchestration AI engine is further configured to: filter data from the data sources based on predefined selection criteria associated with the assigned task portion; determine relevant datasets for execution of the assigned task portion based on the filtering; and transmit the relevant datasets to each agentic AI engine for execution of the assigned task portion.

In some embodiments, for each agentic AI engine, the orchestration AI engine is further configured to: monitor performance metrics associated with execution of the assigned task portion; and dynamically adjust future task portion assignments based on the performance metrics.

In some embodiments, the orchestration AI engine is further configured to: determine an execution order for the plurality of task portions based on at least one of task dependencies, execution constraints, or real-time system conditions.

In some embodiments, for each agentic AI engine, the orchestration AI engine is further configured to: implement an error-handling mechanism to identify inconsistencies in the output; and initiate corrective actions to mitigate the identified inconsistencies, wherein the corrective action comprises reprocessing the assigned task portion, reallocation of assigned task portions, or flagging outputs for manual review.

In some embodiments, the orchestration AI engine is further configured to: dynamically apply a failover mechanism to reassign task portions from underperforming agentic AI engines to alternative agentic AI engines.

In another aspect, a computer program product for orchestrating agentic AI engines is presented. The computer program product comprising a non-transitory computer-readable medium comprising code, which when executed, is configured to cause a processing device to: receive, from an end-point device, an input task request; segment the input task request into a plurality of task portions based on task segmentation criteria; determine a plurality of data sources associated with the plurality of task portions; and assign the plurality of task portions and the plurality of data sources to a plurality of agentic AI engines for execution, wherein each agentic AI engine is configured to: receive a task portion and corresponding data sources for executing the task portion; execute the task portion using the corresponding datasets from the data sources; and generate an output corresponding to the task portion based on the execution of the task portion.

In yet another aspect, a method for orchestrating agentic AI engines is presented. The method comprising: receiving, using an orchestration AI engine, an input task request from an end-point device; segmenting, using the orchestration AI engine, the input task request into a plurality of task portions based on task segmentation criteria; determining, using the orchestration AI engine, a plurality of data sources associated with the plurality of task portions; and assigning, using the orchestration AI engine, the plurality of task portions and the plurality of data sources to a plurality of agentic AI engines for execution, wherein each agentic AI engine is configured to: receive a task portion and corresponding data sources for executing the task portion; execute the task portion using the corresponding datasets from the data sources; and generate an output corresponding to the task portion based on the execution of the task portion.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for orchestrating agentic AI engines, in accordance with an embodiment of the invention;

FIG. 2 illustrates an example functional system architecture, in accordance with an embodiment of the invention;

FIG. 3 illustrates a process flow for orchestrating task-specific AI engines in a multi-layered AI architecture, in accordance with an embodiment of the invention; and

FIG. 4 illustrates a process flow for generating a final output, in accordance with an embodiment of the invention.

### DETAILED DESCRIPTION

### Overview

Embodiments of the disclosure address inefficiencies in artificial intelligence (AI) systems where a single AI engine is trained on a broad range of data and tasked with multiple disparate functions. This approach often leads to incorrect outputs, as the AI engine may apply irrelevant data to a given task. Additionally, real-time AI operations make manual oversight impractical, as AI engines may autonomously make decisions or opt into actions without direct human intervention. To resolve these issues, embodiments of the disclosure provide a system comprising a plurality of agentic AI engines, each specialized for a distinct task and trained on a narrowly defined dataset relevant to that task. An orchestration AI engine sits atop the agentic AI engines, aggregating outputs and determining the appropriate response at a macro level. This structure minimizes erroneous outputs by ensuring that each AI engine processes only relevant data and tasks, while the orchestration AI engine provides oversight and control over AI-generated actions.

Embodiments of the disclosure provide improvements in AI system efficiency by reducing computational resource consumption, improving accuracy, and minimizing manual oversight. By limiting each agentic AI engine to a specific task and dataset, the system reduces redundant processing and unnecessary computations, leading to lower processing, storage, and network resource utilization. The task-specific focus of each agentic AI engine improves precision, thereby reducing the computational load associated with error correction and reprocessing. The orchestration AI engine automates the selection and integration of AI outputs, reducing the need for human intervention and improving decision-making speed. Additionally, the system may adjust computing resources based on the number and types of agentic AI engines operating within the ecosystem, optimizing performance and minimizing unnecessary resource consumption. By implementing a hierarchical AI structure, the system ensures that AI-driven decisions follow a rigorous and predefined process, enhancing reliability in real-time operations.

Embodiments of the disclosure provide measurable technical advantages, including increased efficiency, optimized resource utilization, scalability, and improved decision accuracy. By employing multiple specialized AI engines instead of a single, general-purpose AI engine, the system reduces computational overhead and improves execution speed. The dynamic allocation of resources ensures that processing power is allocated based on real-time system needs, minimizing waste. The architecture allows new agentic AI engines to be integrated or removed dynamically, enabling scalability without compromising system performance. Furthermore, by restricting each AI engine's scope, the system reduces the likelihood of erroneous outputs, leading to more reliable AI-driven actions.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

As used herein, “operatively coupled,” means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

As used herein, an “engine” may refer to a computational module implemented in hardware, software, or a combination thereof, configured to execute predefined processes on input data to generate an output. An engine may perform algorithmic operations, execute machine learning models, apply rule-based logic, manage resource allocation, or facilitate automation within a computing system. An engine may operate as an independent entity or as a component (e.g., subsystem) within a larger system, interacting with other engines to achieve a defined objective.

As used herein, “agentic AI engine” may refer to an artificial intelligence module designed to execute a specific, well-defined task using a constrained dataset that is optimized for its designated function. An agentic AI engine may be trained to operate within a limited problem domain, leveraging task-specific inference mechanisms to generate precise outputs with minimal dependency on extraneous data or generalized AI models. The agentic AI engine may function autonomously within its assigned scope, producing outputs that can be utilized by an end-user, another system module, an orchestration AI engine responsible for integrating multiple agentic AI outputs, and/or the like. In some embodiments, an agentic AI engine may incorporate adaptive learning mechanisms to refine task performance based on real-time feedback, subject to predefined operational constraints.

As used herein, “orchestration AI engine” may refer to an artificial intelligence module configured to manage the coordination, task delegation, data distribution, and integration of outputs generated by multiple agentic AI engines. The orchestration AI engine may dynamically determine which agentic AI engines to engage for a given task based on task parameters, system state, and resource availability. Additionally, the orchestration AI engine may facilitate input data routing to ensure that each agentic AI engine processes only the most relevant data for its assigned task. The orchestration AI engine may further consolidate the outputs of multiple agentic AI engines, perform higher-level decision-making, and execute computational resource optimization to maintain system efficiency. In some embodiments, the orchestration AI engine may implement hierarchical reasoning, access control enforcement, and reinforcement learning techniques to refine task allocation strategies based on historical performance metrics and real-time system conditions.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

### Example System Environment

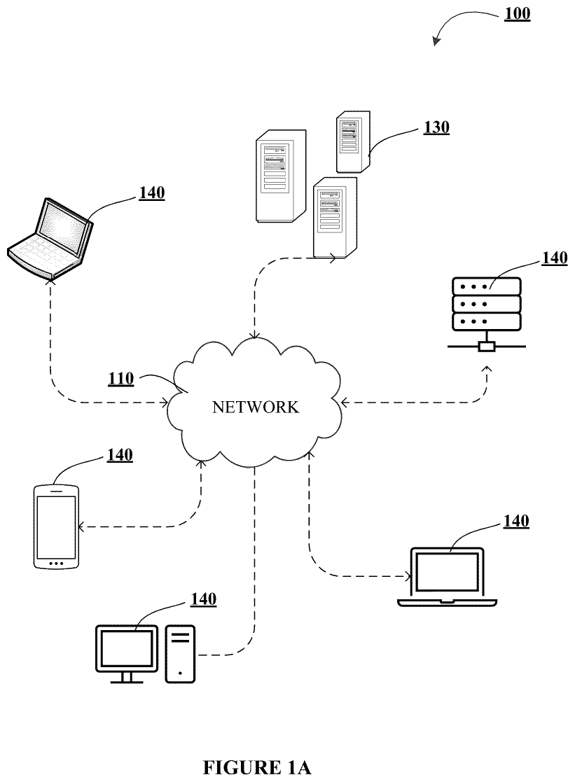

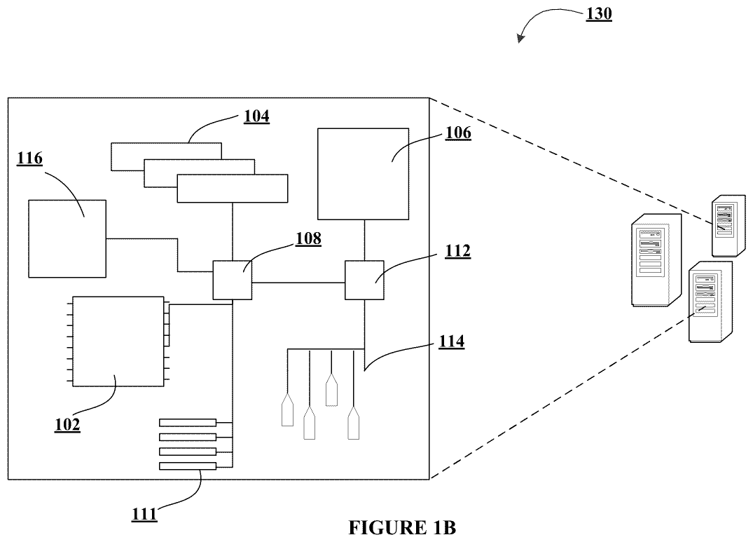

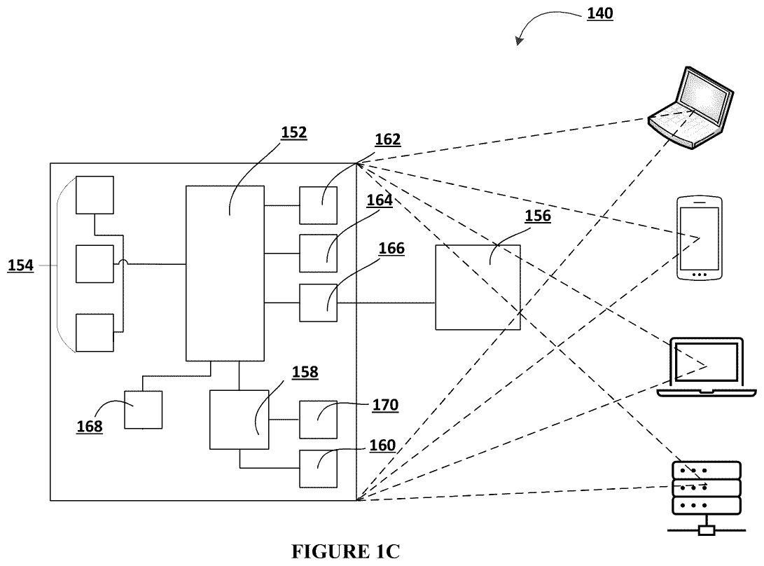

FIGS. 1A-1C illustrate technical components of an exemplary distributed computing environment for orchestrating task-specific AI engines in a multi-layered AI architecture 100, in accordance with an embodiment of the invention. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file servers, or the like, as well as a range of digital computing devices, including laptops, desktops, video recorders, audio/video players, radios, workstations, and/or the like. Additionally, system 130 may include a variety of auxiliary network devices, encompassing wearable devices, Internet-of-things (IoT) devices, electronic kiosk devices, entertainment consoles, mainframes, and/or the like, in any combination to cater to the complexity and diversity of contemporary digital ecosystems.

The end-point device(s) 140 may encompass an array of electronic devices, such as personal digital assistants, cellular telephones, smartphones, laptops, desktops, and merchant input devices like point-of-sale (POS) systems, electronic payment kiosks, and automated teller machines (ATMs). End-point device(s) 140 may also include edge devices like routers, routing switches, integrated access devices (IAD), and/or the like, and devices capable of interfacing with 5G networks, delivering enhanced data processing and connectivity.

The network 110 may include a distributed network architecture that spans a variety of network types, facilitating a cohesive data communication network that can be managed jointly or individually. The network architecture supports shared communication as well as distributed processing across platforms such as telecommunication networks, local area networks (LAN), wide area networks (WAN), global area networks (GAN), the Internet infrastructure, and/or the like. Network 110 may also integrate emerging networking technologies, including software-defined networking (SDN), network function virtualization (NFV), and next-generation wireless communication standards like 5G. Network 110 may employ secure or unsecure, as well as wireless, wired, and optical interconnection technologies, and/or the like, to accommodate a spectrum of communication and processing needs.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the invention. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

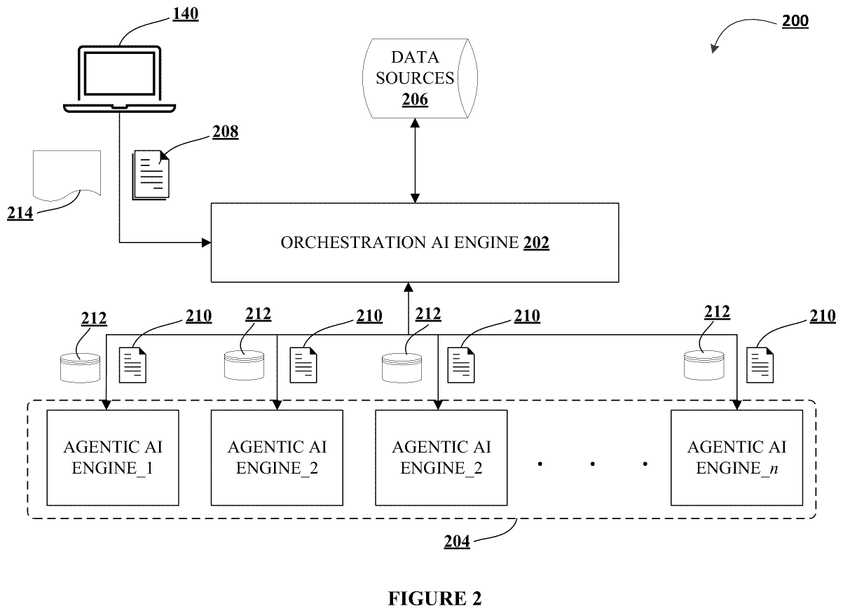

In certain embodiments, the system 130 may be configured to implement a multi-layered AI processing architecture comprising an orchestration AI engine and a plurality of agentic AI engines, as described in further detail in FIG. 2. The orchestration AI engine may reside within or be executed by one or more computing elements of the system 130 and may be operatively coupled to a set of distributed agentic AI engines. These agentic AI engines may be co-located with the orchestration AI engine or distributed across a networked infrastructure, depending on deployment constraints and resource availability.

The orchestration AI engine may be configured to receive input task requests originating from one or more end-point devices 140. Upon receiving such a request, the orchestration AI engine may segment the task into discrete task portions based on predefined task segmentation criteria. These criteria may include functional subcomponents of the task, resource constraints, execution dependencies, or data modality requirements. The orchestration AI engine may assign each segmented task portion to a selected agentic AI engine based on operational capability, which may be assessed using parameters such as historical task performance, available computational capacity, or current system load.

In connection with each assigned task portion, the orchestration AI engine may identify one or more relevant data sources accessible via the network 110 or within the data infrastructure of system 130. The orchestration AI engine may apply selection criteria associated with the task portion to filter or extract specific datasets and may transmit only the filtered subset of relevant data to the corresponding agentic AI engine. Each agentic AI engine may execute its assigned task portion using the received dataset and return an output to the orchestration AI engine upon completion.

The orchestration AI engine may be further configured to receive, process, and aggregate the outputs generated by the agentic AI engines. Such processing may include output validation, ranking, filtering, deduplication, error correction, or other post-processing operations. Based on the processed outputs, the orchestration AI engine may generate a final response, which may then be transmitted to the originating end-point device 140 via the network 110.

In some implementations, the orchestration AI engine may monitor performance metrics associated with each agentic AI engine's execution of its assigned task portion. These metrics may be used to dynamically update future task allocation strategies or to reassign task portions in real time in response to detected performance degradation or system faults. In certain embodiments, the orchestration AI engine may implement a network-wide resource allocation strategy, whereby computing resources are dynamically allocated to agentic AI engines based on the complexity of the assigned task portion and prevailing system-wide constraints such as processor load, network latency, or memory availability.

The orchestration AI engine may additionally implement execution ordering logic for task portions based on dependencies identified during segmentation, and may initiate recovery or failover actions in the event that an agentic AI engine produces an inconsistent output or fails to complete processing. In such cases, the orchestration AI engine may reprocess the task portion, reassign it to an alternative agentic AI engine, or flag the result for manual review or delayed processing.

By distributing task-specific execution across a plurality of agentic AI engines and implementing centralized orchestration logic, the system 130 may achieve improved accuracy, scalability, and efficiency in executing complex AI-driven tasks. The described architecture supports modular task decomposition, data-aware processing delegation, and adaptive orchestration, thereby allowing the system to handle varied task structures and resource conditions in real time.

FIG. 1C illustrates an exemplary component-level structure of the end-point device(s) 140, in accordance with an embodiment of the invention. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

### Example Functional System Architecture

FIG. 2 illustrates an example functional system architecture 200 of the system 130, in accordance with an embodiment of the invention. As shown in FIG. 2, the functional system architecture 200 may include an orchestration AI engine 202 and a plurality of agentic AI engines contained within an agentic AI engine layer 204. The orchestration AI engine 202 is communicatively coupled to one or more data sources 206 and to an end-point device 140 from which task requests may originate.

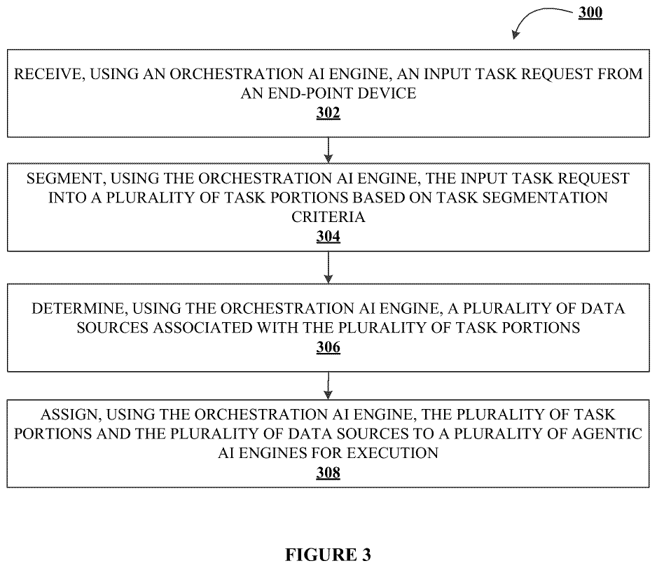

The end-point device 140 may be a user computing device or another networked system component (as described in FIGS. 1A-1C) configured to generate and transmit an input task request 208 to the orchestration AI engine 202. Upon receiving the input task request 208, the orchestration AI engine 202 may process the request and segment it into a plurality of task portions 210 based on task segmentation criteria. Such criteria may include task structure, computational requirements, input type, execution dependencies, or other functional characteristics associated with the request, as described further in FIG. 3.

For each segmented task portion 210, the orchestration AI engine 202 may identify one or more relevant data sources from the data sources 206 and select a corresponding dataset 212 for use in execution. The orchestration AI engine 202 may apply predefined data selection criteria associated with the task portion to determine which subset of the available data is most relevant. The orchestration AI engine 202 may then transmit each task portion 210 and its corresponding dataset 212 to an agentic AI engine within the agentic AI engine layer 204.

Each agentic AI engine within the agentic AI engine layer 204—such as AGENTIC AI ENGINE_1, AGENTIC AI ENGINE_2, through AGENTIC AI ENGINE_n—may be configured to receive a task portion and corresponding dataset from the orchestration AI engine 202. Upon receipt, the agentic AI engine may execute the assigned task portion using the provided dataset and generate an output based on the result of the execution. Once all agentic AI engines (or all agentic AI engine that were assigned task portions) complete execution of their respective task portions, the resulting outputs may be transmitted back to the orchestration AI engine 202. The orchestration AI engine 202 may processes the outputs based on output processing criteria, which may include validation, filtering, ranking, error correction, or aggregation of partial results. Based on this processing, the orchestration AI engine 202 may generate a final output 214 that is transmitted to the end-point device 140 in response to the original task request 208.

In addition to the core task distribution and coordination functions, the orchestration AI engine 202 may perform various auxiliary operations, including determining the operational capability of each agentic AI engine based on task complexity, historical accuracy, resource availability, or processing capability; allocating computational resources dynamically based on the assigned task portion and prevailing network-wide constraints; monitoring execution performance metrics to inform future task assignments; implementing execution ordering based on dependencies or real-time conditions; and executing error-handling and failover mechanisms to maintain operational integrity in the event of processing inconsistencies or system faults.

Although specific embodiments of the system architecture 200 have been described herein, it should be understood that various modifications, substitutions, and alterations may be made without departing from the scope of the invention. The embodiments described herein are illustrative and not limiting. Features described in relation to one embodiment may be combined with features of another embodiment where appropriate.

### Example Methods for Orchestrating Agentic Ai Engines

FIG. 3 illustrates a process flow 300 for orchestrating task-specific AI engines in a multi-layered AI architecture, in accordance with an embodiment of the invention. As shown in block 302, the process flow includes receiving, using an orchestration AI engine, an input task request from an end-point device.

As described herein, the orchestration AI engine may be implemented as a software module, hardware module, or a combination thereof, and may reside within a server, a distributed computing node, or a cloud-based AI service platform. The orchestration AI engine may be configured to receive an input task request originating from an end-point device, which may include a user computing device, an edge device, or another system component capable of interfacing with the orchestration AI engine through a network connection.

The input task request may specify one or more desired outcomes or functions to be performed by the system, and may include structured parameters, such as data types, task categories, priority indicators, or execution constraints, as well as unstructured content such as natural language instructions or multimedia data. Upon receipt, the orchestration AI engine may validate the format and completeness of the task request and prepare it for subsequent segmentation.

In some embodiments, the orchestration AI engine may store metadata associated with received task requests in a task request registry for tracking, audit logging, or subsequent performance tuning. Additionally, the orchestration AI engine may initiate authentication or authorization processes to verify whether the end-point device is permitted to submit the task request, particularly in scenarios involving restricted data or resource-intensive operations.

The orchestration AI engine may also apply contextual analysis to the input task request to identify implicit requirements or dependencies. For example, if the task request pertains to generating a recommendation based on user interaction data, the orchestration AI engine may infer that multiple data domains (e.g., recent user activity, historical patterns, content metadata) are involved and tag this information for use during segmentation and data source identification.

As shown in block 304, the process flow includes segmenting, using the orchestration AI engine, the input task request into a plurality of task portions based on task segmentation criteria. Upon successful receipt and initial processing of the input task request, the orchestration AI engine may segment the request into a plurality of discrete task portions. Task segmentation refers to the decomposition of a unified task request into logically or functionally distinct sub-tasks, each of which may be independently executed by a corresponding agentic AI engine. The orchestration AI engine may apply task segmentation criteria to guide this decomposition. These task segmentation criteria may include, but are not limited to, the functional components of the task, data dependencies, processing modality (e.g., textual analysis, image recognition, signal processing), expected execution complexity, latency constraints, model specialization requirements, and/or the like. For instance, if the input task involves summarizing user feedback and correlating it with product performance metrics, the orchestration AI engine may separate the task into a sentiment analysis portion and a numerical trend analysis portion.

Segmentation may involve one or more predefined segmentation models or dynamic segmentation logic. In some embodiments, the orchestration AI engine may access a task segmentation ruleset stored in memory or loaded from a configuration repository. In other embodiments, the orchestration AI engine may apply machine learning-based classifiers to determine appropriate breakpoints in the task structure, using training data from prior task executions.

Each resulting task portion may be represented in a structured format, such as a task object or execution payload, containing both instructions for execution and metadata indicating dependencies, priority, and execution parameters. The orchestration AI engine may also determine whether any of the task portions are interdependent or may be executed concurrently.

Alternative implementations may support hierarchical segmentation, where a complex task is first divided into intermediate categories and subsequently into granular task portions. The orchestration AI engine may retain a mapping between the original task request and its segmented components to facilitate later output integration or diagnostic tracing.

As shown in block 306, the process flow includes determining, using the orchestration AI engine, a plurality of data sources associated with the plurality of task portions. Following segmentation of the input task request, the orchestration AI engine may identify one or more data sources required for execution of each task portion. In this regard, the orchestration AI engine may map each segmented task portion to its corresponding data requirements and locate the relevant data sources from which the necessary datasets may be obtained. The orchestration AI engine may maintain access to a collection of distributed or centralized data sources, which may include databases, data lakes, file systems, streaming data feeds, structured repositories, or external APIs. Each data source may be categorized by domain, schema, format, or access policy. The orchestration AI engine may consult a data catalog or data source registry to identify candidate sources for a given task portion.

To determine which data sources are appropriate, the orchestration AI engine may evaluate selection criteria associated with the task portion. Such criteria may include the expected data modality (e.g., image, text, numeric), time sensitivity, data freshness, historical range, or any domain-specific constraints. For example, a task portion requiring sentiment analysis on customer reviews may trigger access to recent customer feedback logs stored in a time-indexed database, while another portion involving trend detection may require structured historical metrics from a business intelligence data warehouse.

In some embodiments, the orchestration AI engine may also apply data filtering or transformation logic to determine appropriate data sources. For example, the orchestration AI engine may limit data selection based on temporal windows, geographic scope, or data quality thresholds. The identified datasets may then be tagged or labeled with identifiers linking them to their respective task portions.

The orchestration AI engine may optionally enforce data access control policies at this stage. If a particular task portion requires access to protected or sensitive data, the orchestration AI engine may validate user or process permissions before associating the data source with the task. Secure transmission protocols or encryption schemes may be selected based on the data classification and destination agentic AI engine.

In specific embodiments, when determining the appropriate data sources the system may accommodate overall system conditions. If one or more data sources are inaccessible or under high load, the orchestration AI engine may identify alternate or redundant sources capable of fulfilling the same data requirements, thereby contributing to system resilience.

As shown in block 308, the process flow includes assigning, using the orchestration AI engine, the plurality of task portions and the plurality of data sources to a plurality of agentic AI engines for execution. After segmenting the input task request and determining the associated data sources, the orchestration AI engine proceeds to assign each task portion, along with its corresponding data source(s), to one or more agentic AI engines for execution. Each agentic AI engine may be configured to execute a discrete task within a constrained operational domain, and may operate independently from other agentic AI engines within the system.

The assignment process may be based on a matching operation performed by the orchestration AI engine. For each task portion, the orchestration AI engine may evaluate the operational characteristics and suitability of available agentic AI engines. Such an evaluation may include factors such as task-type compatibility, prior execution history, success rates, processing latency, and current system load. In some embodiments, a capability profile may be maintained for each agentic AI engine, enabling the orchestration AI engine to identify optimal candidates for specific task types.

Once a target agentic AI engine is identified for a given task portion, the orchestration AI engine may generate and transmit an execution package containing both the task instructions and a reference or copy of the filtered dataset derived from the associated data source(s). Such an execution package may include metadata specifying expected output format, execution priority, and fault-handling parameters.

In some implementations, resource-aware scheduling may be incorporated into the assignment step. The orchestration AI engine may dynamically allocate computational resources—such as memory, processor threads, or bandwidth—to each agentic AI engine based on the projected load of the assigned task portion and any prevailing network-wide resource constraints. This may include predictive adjustments to accommodate downstream execution requirements or to prevent overcommitment of shared infrastructure.

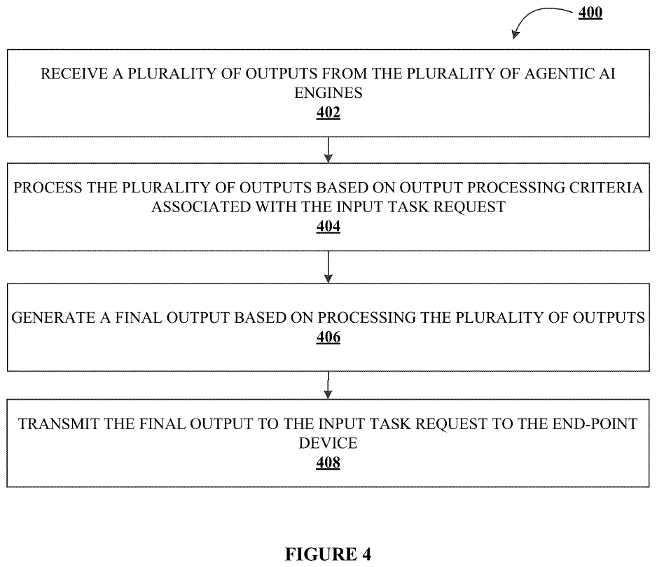

Each agentic AI engine, upon receiving the task portion and dataset, may then proceed to execute the assigned instructions. The orchestration AI engine may track execution status, monitor progress, and maintain task-to-engine mappings to facilitate later output processing, error handling, or performance diagnostics, as described in detail in FIG. 4.

In alternative embodiments, the orchestration AI engine may support redundant execution paths by assigning the same task portion to multiple agentic AI engines and selecting among the outputs based on confidence scoring or consensus models.

FIG. 4 illustrates a process flow 400 for generating a final output, in accordance with an embodiment of the invention. As shown in block 402, the process flow includes receiving a plurality of outputs from the plurality of agentic AI engines.

After the orchestration AI engine assigns task portions and corresponding datasets to a plurality of agentic AI engines, each agentic AI engine executes its assigned task portion and generates an output specific to that execution. These outputs may include predictions, classifications, analytical results, or any other task-specific data, depending on the nature of the original input task request.

The orchestration AI engine may be configured to receive the plurality of outputs from the agentic AI engines. The orchestration AI engine may receive the outputs asynchronously, as each agentic AI engine may complete its assigned task portion at a different time based on the complexity and required resources. In some embodiments, the orchestration AI engine maintains a tracking registry to monitor the status of task execution and output availability for each task portion. Each output received may be tagged or identified with metadata linking it to the corresponding task portion, execution parameters, confidence score, or agentic engine identifier. The orchestration AI engine may temporarily store the received outputs in memory or in an output staging module pending further processing.

In alternative implementations, the orchestration AI engine may incorporate integrity validation procedures at this stage, verifying that each received output satisfies formatting requirements, falls within acceptable value ranges, or is complete. If an expected output is missing, malformed, or delayed, the orchestration AI engine may initiate corrective action such as timeout handling, reprocessing, or reassignment of the task portion to another agentic AI engine.

As shown in block 404, the process flow includes processing the plurality of outputs based on output processing criteria associated with the input task request. Once the outputs are received from the agentic AI engines, the orchestration AI engine may proceed to process these outputs using one or more output processing criteria. The output processing criteria may be predefined, dynamically determined based on the input task request, or selected based on contextual parameters such as task type, priority, or output modality.

Processing the outputs may involve a variety of operations, including but not limited to validation, ranking, filtering, conflict resolution, deduplication, normalization, and synthesis. For example, if the task request required independent evaluations of a common dataset (e.g., for consensus scoring), the orchestration AI engine may apply a weighting mechanism to integrate the outputs. In another example, if each output corresponds to a distinct sub-function, the orchestration AI engine may collate and reorder the outputs to form a coherent structure aligned with the original task's intended logic.

The output processing criteria may also account for additional metadata accompanying each output, such as execution time, resource consumption, or confidence score. These attributes may influence how the orchestration AI engine prioritizes or interprets the received outputs. In some embodiments, statistical or machine learning models may be used to identify anomalies or patterns in the outputs, which may affect how the final output is assembled.

In further embodiments, if an output is inconsistent with expectations or falls outside an acceptable threshold, the orchestration AI engine may initiate a corrective action, including requesting re-execution of the task portion, reweighting the output, or flagging the result for deferred review. The orchestration AI engine may also log this stage of processing for traceability or post-analysis.

As shown in block 406, the process flow includes generating a final output based on processing the plurality of outputs. Following the application of output processing criteria, the orchestration AI engine may generate a final output that represents a resolved, consolidated, or aggregated result of the individual outputs received from the plurality of agentic AI engines. The final output may be structured according to a format or specification defined by the input task request, system specified, or a contextual output model. The orchestration AI engine may construct the final output by combining, summarizing, or synthesizing the processed outputs into a unified response. For example, if the task request involved multi-part analysis (e.g., classification, prediction, and recommendation), the final output may include each of these elements in a defined sequence or as nested components of a structured object. In other cases, the orchestration AI engine may apply a template or schema to format the result for compatibility with downstream systems or user interfaces.

In some embodiments, the orchestration AI engine may append metadata to the final output, such as an execution summary, confidence indicators, task lineage, or processing time metrics. Such information may be useful for auditability, debugging, or further analysis by the requesting entity.

Alternative implementations may support adaptive output generation strategies. For instance, if the input task request specifies different levels of output granularity (e.g., summary versus full analysis), the orchestration AI engine may conditionally include or omit specific processed results. The system may also support extensible output formatting modules, enabling the orchestration AI engine to emit the final output in different serializations (e.g., JSON, XML, binary) based on target system compatibility.

The final output forms the complete response that fulfills the input task request and is prepared for transmission to the originating end-point device.

As shown in block 408, the process flow includes transmitting the final output to the input task request to the end-point device. Once the final output has been generated, the orchestration AI engine transmits the output to the end-point device that originated the input task request. In some implementations, the orchestration AI engine may include additional delivery metadata, such as timestamps, transmission identifiers, or acknowledgment tokens to confirm receipt. In embodiments involving sensitive data or regulated environments, the orchestration AI engine may apply encryption, digital signatures, or access control tokens during transmission to maintain confidentiality, authenticity, and integrity of the transmitted output.

Embodiments of the present disclosure are described below with reference to block diagrams and flowchart illustrations. Thus, it should be understood that each block of the block diagrams and flowchart illustrations may be implemented in the form of a computer program product; an entirely hardware embodiment; an entirely firmware embodiment; a combination of hardware, computer program products, and/or firmware; and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the methods described above may include fewer steps in some cases, while in other cases the methods may include additional steps. The steps of the methods and modifications to the steps of the methods described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for orchestrating agentic AI engines, the system comprising:
a plurality of agentic AI engines; and
an orchestration AI engine operatively coupled to the plurality of agentic AI engines, wherein each agentic AI engine is configured to:
receive, from the orchestration AI engine, a task portion and corresponding data sources for executing the task portion;
execute the task portion using datasets from the corresponding data sources; and
generate an output corresponding to the task portion based on the execution of the task portion, and
wherein the orchestration AI engine is configured to:
receive, from an end-point device, an input task request;
segment the input task request into a plurality of task portions based on task segmentation criteria;
determine a plurality of data sources associated with the plurality of task portions; and
assign the plurality of task portions and the plurality of data sources to the plurality of agentic AI engines for execution.

2. The system of claim 1, wherein the orchestration AI engine is further configured to:
receive a plurality of outputs from the plurality of agentic AI engines;
process the plurality of outputs based on output processing criteria associated with the input task request;
generate a final output based on processing the plurality of outputs; and
transmit the final output to the input task request to the end-point device.

3. The system of claim 1, wherein the orchestration AI engine is further configured to:
determine operational capability of each agentic AI engine based on at least one of a task complexity, processing capability, historical accuracy, or resource availability; and
assign the plurality of task portions to the plurality of agentic AI engines based on the operational capability of each agentic AI engine.

4. The system of claim 3, wherein the orchestration AI engine is further configured to:
dynamically allocate computational resources to each agentic AI engine based on at least one of a complexity of the assigned task portion, data processing requirements of the assigned task portion, or an expected computational load associated with executing the assigned task portion.

5. The system of claim 4, wherein, for each agentic AI engine, the orchestration AI engine is further configured to:
filter data from the data sources based on predefined selection criteria associated with the assigned task portion;
determine relevant datasets for execution of the assigned task portion based on the filtering; and
transmit the relevant datasets to each agentic AI engine for execution of the assigned task portion.

6. The system of claim 1, wherein, for each agentic AI engine, the orchestration AI engine is further configured to:
monitor performance metrics associated with execution of the assigned task portion; and
dynamically adjust future task portion assignments based on the performance metrics.

7. The system of claim 1, wherein the orchestration AI engine is further configured to:
determine an execution order for the plurality of task portions based on at least one of task dependencies, execution constraints, or real-time system conditions.

8. The system of claim 1, wherein, for each agentic AI engine, the orchestration AI engine is further configured to:
implement an error-handling mechanism to identify inconsistencies in the output; and
initiate corrective actions to mitigate the identified inconsistencies, wherein the corrective action comprises reprocessing the assigned task portion, reallocation of assigned task portions, or flagging outputs for manual review.

9. The system of claim 1, wherein the orchestration AI engine is further configured to:
dynamically apply a failover mechanism to reassign task portions from underperforming agentic AI engines to alternative agentic AI engines.

10. A computer program product for orchestrating agentic AI engines, the computer program product comprising a non-transitory computer-readable medium comprising code, which when executed, is configured to cause a processing device to:
receive, from an end-point device, an input task request;
segment the input task request into a plurality of task portions based on task segmentation criteria;
determine a plurality of data sources associated with the plurality of task portions; and
assign the plurality of task portions and the plurality of data sources to a plurality of agentic AI engines for execution,
wherein each agentic AI engine is configured to:
receive a task portion and corresponding data sources for executing the task portion;
execute the task portion using the corresponding datasets from the data sources; and
generate an output corresponding to the task portion based on the execution of the task portion.

11. The computer program product of claim 10, wherein the code, when executed, is further configured to:
receive a plurality of outputs from the plurality of agentic AI engines;
process the plurality of outputs based on output processing criteria associated with the input task request;
generate a final output based on processing the plurality of outputs; and
transmit the final output to the input task request to the end-point device.

12. The computer program product of claim 10, wherein the code, when executed, is further configured to:
determine operational capability of each agentic AI engine based on at least one of a task complexity, processing capability, historical accuracy, or resource availability; and
assign the plurality of task portions to the plurality of agentic AI engines based on the operational capability of each agentic AI engine.

13. The computer program product of claim 12, wherein the code, when executed, is further configured to:
dynamically allocate computational resources to each agentic AI engine based on at least one of a complexity of the assigned task portion, data processing requirements of the assigned task portion, or an expected computational load associated with executing the assigned task portion.

14. The computer program product of claim 13, wherein the code, when executed, is further configured to, for each agentic AI engine:
filter data from the data sources based on predefined selection criteria associated with the assigned task portion;
determine relevant datasets for execution of the assigned task portion based on the filtering; and
transmit the relevant datasets to each agentic AI engine for execution of the assigned task portion.

15. The computer program product of claim 10, wherein the code, when executed, is further configured to, for each agentic AI engine:
monitor performance metrics associated with execution of the assigned task portion; and
dynamically adjust future task portion assignments based on the performance metrics.

16. The computer program product of claim 10, wherein the code, when executed, is further configured to:
determine an execution order for the plurality of task portions based on at least one of task dependencies, execution constraints, or real-time system conditions.

17. A method for orchestrating agentic AI engines, the method comprising:
receiving, using an orchestration AI engine, an input task request from an end-point device;
segmenting, using the orchestration AI engine, the input task request into a plurality of task portions based on task segmentation criteria;
determining, using the orchestration AI engine, a plurality of data sources associated with the plurality of task portions; and
assigning, using the orchestration AI engine, the plurality of task portions and the plurality of data sources to a plurality of agentic AI engines for execution,
wherein each agentic AI engine is configured to:
receive a task portion and corresponding data sources for executing the task portion;
execute the task portion using the corresponding datasets from the data sources; and
generate an output corresponding to the task portion based on the execution of the task portion.

18. The method of claim 17, wherein the method further comprises:
receiving, using the orchestration AI engine, a plurality of outputs from the plurality of agentic AI engines;
processing, using the orchestration AI engine, the plurality of outputs based on output processing criteria associated with the input task request;
generating, using the orchestration AI engine, a final output based on processing the plurality of outputs; and
transmitting, using the orchestration AI engine, the final output to the input task request to the end-point device.

19. The method of claim 17, wherein the method further comprises:
determining, using the orchestration AI engine, operational capability of each agentic AI engine based on at least one of a task complexity, processing capability, historical accuracy, or resource availability; and
assigning, using the orchestration AI engine, the plurality of task portions to the plurality of agentic AI engines based on the operational capability of each agentic AI engine.

20. The method of claim 17, wherein the method further comprises:
dynamically allocating, using the orchestration AI engine, computational resources to each agentic AI engine based on at least one of a complexity of the assigned task portion, data processing requirements of the assigned task portion, or an expected computational load associated with executing the assigned task portion.
